(19) United States
(12) Patent Application Publication
(10) Pub. No.: US 2026/0303654 A1
(43) Pub. Date: Oct. 1, 2026

(54) AUTOMATED THREAT OPERATIONS MACHINE

(71) Applicant: International Business Machines Corporation, Armonk, NY (US)

(72) Inventors: Aankur Bhatia, Bethpage, NY (US); HuyAnh Dinh Ngo, Sterling Heights, MI (US); Srinivas Babu Tummalapenta, Broomfield, CO (US); David Michael McGinnis, Roswell, GA (US)

(73) Assignee: International Business Machines Corporation, Armonk, NY (US)

(21) Appl. No.: 19/093,972

(22) Filed: Mar. 28, 2025

(51) Int. Cl. H04L 9/40; G06Q 30/04; H04L 41/16

(52) U.S. Cl. CPC H04L 63/1441; G06Q 30/04; H04L 41/16

(57) ABSTRACT

An embodiment decomposes, within a decomposition module of a security agent manager application, a signal received at a data input interface of the security agent manager application into a set of attributes. The embodiment generates within an investigation plan module an investigation plan based on the set of attributes, the investigation plan comprising a set of actionable tasks. The embodiment identifies within an agent registry module a first agent capable of executing a first task of the set of actionable tasks. The embodiment assigns within an agent deployment module the first agent to the first task, where executing the first task produces a first execution result. The embodiment performs within a response module a responsive action based on the first execution result.

### BACKGROUND

The present invention relates generally to cybersecurity. More particularly, the present invention relates to a method, system, and computer program providing a multi-agent system for automating threat operations, including an automated threat operations machine.

Artificial intelligence (AI) technology has evolved significantly over the past few years. Modern AI systems are achieving human level performance on cognitive tasks like converting speech to text, recognizing objects and images, or translating between different languages. This evolution holds promise for new and improved applications in many industries.

An Artificial Neural Network (ANN)-also referred to simply as a neural network-is a computing system made up of a number of simple, highly interconnected processing elements (nodes), which process information by their dynamic state response to external inputs. ANNs are processing devices (algorithms and/or hardware) that are loosely modeled after the neuronal structure of the mammalian cerebral cortex but on much smaller scales. A large ANN might have hundreds or thousands of processor units, whereas a mammalian brain has billions of neurons with a corresponding increase in magnitude of their overall interaction and emergent behavior.

A Large Language Model (LLM) is a type of machine learning model designed for natural language processing tasks. An LLM may be trained on immense amounts of data, enabling the LLM to be capable of understanding and generating natural language and other types of content to perform a wide range of tasks. LLMs today may have the ability to the ability to infer from context, generate coherent and contextually relevant responses, translate between different languages, summarize text, answer questions, respond to queries, and even assist in creative writing or code generation tasks.

An artificial intelligence (AI) agent refers to a system or program that is capable of autonomously performing tasks on behalf of a user or another system by designing its workflow and utilizing available tools. AI agents can encompass a wide range of functionalities beyond natural language processing including decision-making, problem-solving, interacting with external environments, and executing actions. These agents can be deployed in various applications to solve complex tasks in various contexts from software design and IT automation to code-generation tools and conversational assistants. AI agents often leverage large language models (LLMs) to comprehend and respond to user inputs step-by-step and determine when to call on external tools. AI agents are sometimes referred to as LLM agents if they incorporate an LLM in their functioning.

### SUMMARY

The illustrative embodiments provide for a dynamic multi-agent system for automating threat investigation operations. An embodiment decomposing within a decomposition module of a security agent manager application a signal into a set of attributes, the signal being received at a data input interface of the security agent manager application. The embodiment also includes generating within an investigation plan module of the security agent manager application an investigation plan based on the set of attributes, the investigation plan comprising a set of actionable tasks. The embodiment also includes identifying within an agent registry module of the security agent manager application a first agent capable of executing a first task of the set of actionable tasks. The embodiment also includes assigning within an agent deployment module of the security agent manager application the first agent to the first task, the assigning causing executing, by the first agent, the first task, the executing the first task producing a first execution result. The embodiment also includes performing within a response module of the security agent manager application, upon receiving the first execution result at the data input interface of the security agent manager application, a responsive action, the responsive action based on the first execution result.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example computing environment in accordance with an illustrative embodiment;

FIG. 3 depicts a block diagram of an example software module in accordance with an illustrative embodiment;

FIG. 4 depicts a block diagram of an example multi-agentic system for automated threat investigation in accordance with an illustrative embodiment;

FIG. 5 depicts a block diagram of an example process for dynamic agent assignment and creation in accordance with an illustrative embodiment;

FIG. 6 depicts a block diagram of an example process for automated threat investigation in accordance with an illustrative embodiment;

FIG. 7 depicts a flowchart of an example process for automated threat investigation in accordance with an illustrative embodiment;

FIG. 8 depicts a flowchart of an example process for automated threat investigation in accordance with an illustrative embodiment; and

FIG. 9 depicts a flowchart of an example process for dynamic agent assignment and creation in accordance with an illustrative embodiment.

### DETAILED DESCRIPTION

Cybersecurity is the practice of protecting systems, networks, and programs from digital attacks. Cyberattacks can manifest in various forms, usually involving accessing, changing, or destroying sensitive information, or interrupting normal system operations. Effective cybersecurity practices are aimed to prevent security threats that may lead to unauthorized information disclosure, theft, or damage to hardware, software, or data, as well as the disruption or misdirection of the services that a system or organization may provide.

Some common types of cyberthreats include, but are not limited to: malware, ransomware, phishing, credential theft and abuse, insider threats, AI attacks, cryptojacking, and distributed denial of service (DDoS) attacks. To prevent or mitigate these threats, systems and organizations may employ various tools, procedures, and strategies. Some common cybersecurity tools that may be employed may include, but are not limited to, firewalls, antivirus/anti-malware software, intrusion detection/prevention systems (IDS/IPS), security information and event management (SIEM), endpoint detection and response (EDR), vulnerability scanners, encryption tools, and multifactor authentication. Some common cybersecurity practices that may be employed may include, but are not limited to, risk assessments and vulnerability management, patch management, incident response planning, penetration testing and security audits, and backup and disaster recovery procedures. Some other common cybersecurity practices that may be employed may include, but are not limited to, zero trust architecture, network segmentation, continuous monitoring, threat intelligence sharing, and compliance with established cybersecurity frameworks.

Systems and organizations today often employ a security operations center (“SOC”) to monitor, prevent, mitigate, and/or remediate potential security threats. Based on an indicator of compromise (“IoC”) detected, the SOC may employ various different tools and strategies to effectively respond to the IoC. However, current SOC operations today are exceedingly labor intensive. Typically, these operations require highly trained security analysts to execute. Further, these operations are often slowed and may event come to a halt when one security analyst is dependent on another security analyst to perform a particular operation.

Despite improved capabilities of cybersecurity technologies to detect and mitigate cyberthreats, currently existing cybersecurity technologies are nevertheless inefficient and ineffective for threat monitoring and incident response for various reasons. Over reliance on human actors serving as security analysts can leave a system and organization vulnerable to cyberattacks. As mentioned, security teams can often be slow and inefficient due to the labor-intensive nature of threat investigation. Also, security analysts may likewise be inconsistent in and/or misaligned in their response strategies, especially when they are relying on their own subjective experience.

Currently there is no way to employ a coordinated multi-agentic system for cybersecurity threat investigation and response. Accordingly, there is currently no holistic system that leverages capabilities of various agents comprising various tools for different aspects and purposes related to cybersecurity. Further, there are no currently existing processes or strategies that consider dynamically configuring and assigning AI agents to execute specific tasks of a uniquely generated investigation plan. These current limitations make it impossible to provide efficient and effective cybersecurity.

The present disclosure addresses the deficiencies described above by providing a process (as well as a system, method, machine-readable medium, etc.) that develops a dynamic multi-agentic threat operations machine that considers each of the various aspects of threat investigation and leverages a combination of various machine learning based architectures to provide comprehensive and efficient threat investigation. Disclosed embodiments combine distinct capabilities of specially trained agents to automate threat investigation and continuously adapt to emerging cyberthreats. Disclosed embodiments may also automatically configure and/or train a new agent in an event that there is no available agent capable of executing a particular task of an investigation plan.

The illustrative embodiments provide for an automated threat operation machine (also referred to as “ATOM”). A “cyberthreat” or “threat” as referred to herein is potential negative action or event across a system or organization that may be the due to a system vulnerability and that may result in an unwanted impact on a computer system, component, and/or application. Embodiments disclosed herein describe the dynamic multi-agentic automated system in relation to threat investigation; however, use of this example is not intended to be limiting but is instead used for descriptive purposes only.

Accordingly, the embodiments of the present disclosure may be adapted for any domain where the generation of an action plan and automated execution of an action plan can provide a benefit. For example, embodiments of the present disclosure may be adapted for healthcare to generate an investigation plan and automatically perform tasks of the investigation plan based on data or a received signal containing health related data. For example, in the medical field, the system can process diagnostic test results by breaking down diagnostic results into distinct attributes and assigning specialized agents to perform individualized tasks based on each attribute. As another example, embodiments of the present disclosure may be adapted for the financial domain to generate an investment strategy and automatically perform actions according to a uniquely generated and personalized investment strategy. These and various other embodiments will be further described in the application, following a description of the drawings.

As used throughout the present disclosure, the term “agent” refers to an autonomous software entity that utilizes one or more artificial intelligence algorithms and techniques to perceive its environment, make decisions, and take actions to achieve specific goals or tasks. An agent may be designed to operate independently, adapt to changing conditions, and interact with an environment to accomplish predefined or emergent objectives. Further, an agent may be designed to work cooperatively with one or more agents. Further, an agent may be configured to learn from past experience, make future predictions, and optimize actions based on feedback and data inputs. Embodiments of the present disclosure consider leveraging one or more LLMs to enable and/or improve the designed functions of an agent. Examples of tasks that may be automatically performed by an agent may include, but are not limited to, analyzing text, classifying content, extracting information, aggregating, correlating, and pattern matching, summarizing information, highlighting insights, interacting with external systems, and/or reporting as per requirements, formats, and personas. As used throughout the present disclosure, the term “agent” may be used interchangeably with the terms “artificial intelligence agent”, “AI agent”, and “autonomous agent” and similar terms, unless specifically indicated by the context.

As used throughout the present disclosure, the term “manager agent” refers to an autonomous software entity within a system that is responsible for coordinating, delegating, and/or overseeing the execution of tasks among other agents within the system. In some embodiments, the manager agent may employ one or more predefined algorithms, rules, and decision-making processes to assign tasks, monitor progress, and optimize resource allocation to ensure efficient and effective operation of the system. In some embodiments, the manager agent may dynamically generate a strategy, investigation plan, and/or sequence of actionable tasks to execute based on specific data or a signal received by the manager agent from another system or user. The manager agent may serve as a central control unit that manages the interactions and workflows of multiple agents, thereby facilitating the achievement of system and/or organizational objectives and goals in a coordinated manner.

As used throughout the present disclosure, the term “investigation plan” refers to a structured and predefined set of tasks, procedures, and actions designed to guide the systematic investigation, analysis, and response to security incidents or potential threats within a system. In some embodiments, the investigation plan outlines a sequence of steps to be followed, the objectives to be achieved, and the resources required to conduct a thorough examination of security events, anomalies, or breaches. In some embodiments, the investigation plan serves as a plan for security agents and/or teams, detailing the investigative process, data collection methods, analysis techniques, and response strategies to effectively detect, assess, and mitigate security risks. The investigation plan provides a framework for organizing and coordinating security operations, thereby ensuring a methodical and comprehensive approach to addressing security incidents and safeguarding the integrity of the system. Embodiments of the present disclosure consider dynamically generating an investigation plan based on a received threat signal and/or user preferences. As used throughout the present disclosure, the term “investigation plan” may be used interchangeably with the term “action plan” and similar terms, unless specifically indicated by the context.

As used throughout the present disclosure, the term “tool” refers to a software component or module that provides a specific function or functions to an agent within a system, enabling the agent to perform one or more specialized tasks. Tools may be designed to support various operations, such as data analysis, threat detection, data enrichment, system monitoring, report generation, and other automated responsive actions, including various security and non-security related operations. By offering predefined functionalities that facilitate task execution, each tool is tailored to address a particular aspect of the task at hand, providing the agent with the necessary features, resources, permissions, and/or capabilities to accomplish a specified task in a structured and optimized manner.

As used throughout the present disclosure, the term “agent registry” refers to centralized database or repository within a system that stores information about registered agents, including their unique identifiers, capabilities, and associated tools. The agent registry serves as a mapping that maintains a record of each agent within the system, along with details regarding the tools and functions available to them. By storing essential information about agents and their capabilities, the agent registry enables efficient management, allocation, and deployment of agents for executing tasks and operations within the system. The agent registry provides a structured framework for identifying, categorizing, and accessing agent resources, facilitating effective coordination and utilization of agent functionalities to support system operations and objectives.

As used throughout the present disclosure, the term “security operations center” (or simply “SOC”) refers to a system or organization responsible for protecting another system or organization against cyber threats. A SOC typically employs human security analysts who are designated to monitor an organization's network and investigate any potential security incidents that may be detected. Some example SOC operations may include, but are not limited to, data collection, data normalization, data transformation, data aggregation, data correlation, pattern matching, data enrichment, contextualization, similarity (duplicate) analysis, threat disposition, responsive action recommendation, threat mitigation, and/or report writing. It is contemplated herein an individual AI agent may be designed and trained a perform each operation of one or more of the SOC operations, and the manager agent may deploy one or more agents to accomplish one or more tasks depending on the SOC operation capabilities of each agent.

Illustrative embodiments include decomposing, within a decomposition module of a security agent manager application, a signal into a set of attributes, the signal being received at a data input interface of the agent manager application. In an embodiment, the signal corresponds to a potential security threat or alert. In an embodiment, the attributes correspond to aspects related to cyber security threat investigation. In an embodiment, the signal is received from an external security system or device.

Illustrative embodiments further include generating, within an investigation plan module of the agent manager application, an investigation plan based on the set of attributes, the investigation plan comprising a set of actionable tasks. Illustrative embodiments further include identifying, within an agent registry module of the agent manager application, a first agent capable of executing a first task of the set of actionable tasks.

Illustrative embodiments further include determining whether there is an agent capable of executing each task of the set of actionable tasks. In an embodiment, in an event there is no agent available that may perform a particular task of the set of actionable tasks, or in an event that not every task of the set of actionable tasks may be accomplished by the available agents, the process includes configuring and training a new agent to be able to accomplish the previously unassigned task. Accordingly, in an embodiment, in an event that not every task of the investigation plan is assigned to a respective agent or agent, the process creates a new agent and assigns the new agent to the previously unassigned task.

Illustrative embodiments further include assigning, within an agent deployment module of the agent manager application, the first agent to the first task. In an embodiment, assigning the first agent to the first task causes the first agent to execute the first task. In an embodiment, executing the first task produces a first execution result. In an embodiment, each task of the investigation plan is assigned to a different particular agent that is configured with a particular capability and/or tooling that enables the agent to be able to accomplish the particular assigned task.

Illustrative embodiments further include performing, within a response module of the agent manager application, a responsive action upon receiving the first execution result at the data input interface of the agent manager application. In an embodiment, the responsive action is based on the first execution result. In an embodiment, the responsive action includes modifying the investigation plan. In an embodiment, the responsive action includes modifying the assignment of tasks to agents. In an embodiment, the responsive action includes configuring a new agent to perform a new task.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

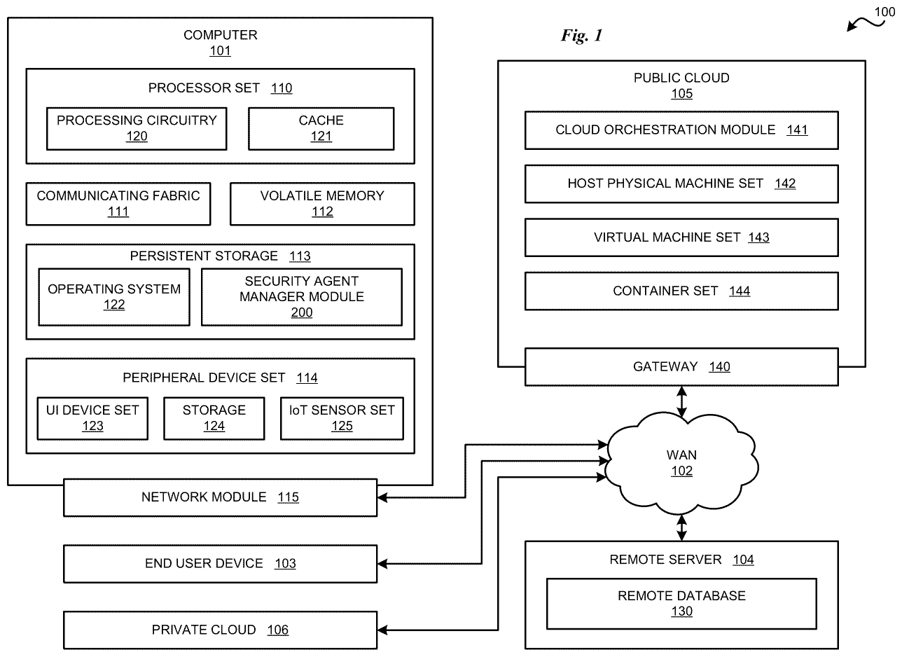

FIG. 1 depicts a block diagram of a computing environment 100. Computing environment 100 contains an example of an environment for the execution of at least some of the computer code involved in performing the inventive methods, such as security agent manager module 200 that provides automated threat investigation. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

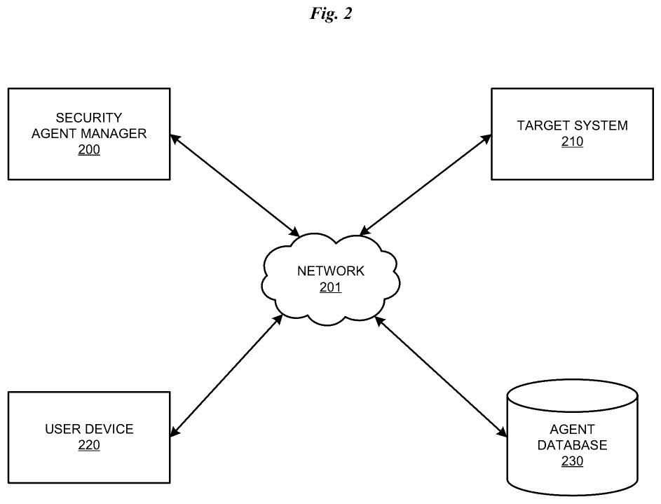

FIG. 2 depicts a block diagram of an example computing environment in accordance with an illustrative embodiment. In the illustrated embodiment, the security agent manager module 200 includes the security agent manager module 200 of FIG. 1. In the illustrative embodiment, the security agent manager 200 is configured to selectively assign one or more agents to accomplish one or more tasks of an investigation plan that has been generated by the manager module 200 in response to receiving a threat signal from target system 210. In an embodiment, the manager module 200 assigns an agent to a task based on the available tooling of that agent. Accordingly, each agent may be designed, programmed, trained, fine-tuned, etc. to perform specific functions based on the needs, desires, and/or requirements of the system and/or attributes of the threat signal received. In an embodiment, agents may be individually programmed with specific functions tailored to address different aspects of security threats.

In the illustrated embodiment, the security agent manager 200 is configured to automate the functions of a Security Operations Center (SOC) corresponding to a target system 210, thereby reducing the need for manual intervention in security threat investigations. Traditional SOC tasks, such as collecting intelligence, enriching data, and correlating information, require analysts to manually retrieve information from various systems, including asset management tools, to determine device ownership, group association, and security risks. The security agent manager 200 leverages various AI models in a multi-agentic framework to be able to execute all tasks traditionally performed by a SOC autonomously.

In an embodiment, the multi-agentic system operates through a hierarchical structure of AI agents, which may include the central security agent manager 200 agent configured to generate investigation tasks and distribute the investigation tasks among specially tooled agents. In some embodiment, the worker agents may function independently, though may coordinate when desired or necessary, and may be configured to perform various tasks, including but not limited to, data enrichment, correlation, and deduplication, and various other tasks in parallel. By automating this workflow, the multi-agentic system significantly reduces the time required to complete a threat investigation while ensuring comprehensive threat analysis.

In an embodiment, upon receiving a security alert from target system 210, the manager agent dynamically constructs an investigation plan tailored to the specific case based on the security alert. The investigation plan may include various tasks such as, for example, IP enrichment, asset contextualization, and risk assessment, and then assign those tasks to the relevant agents, who execute their functions and return the results the manager agent, another worker agent, or a user having sufficient privileges, for further analysis.

In an embodiment, the agent database 230 includes a repository for all data relating to security agent manager module 200. In an embodiment, the agent database 230 stores an agent registry. In an embodiment, the agent registry defines agents according to tools that the agents possess. In an embodiment, the agent registry categorizes agents based on their capabilities, functions, and associated tools. Accordingly, the agent registry serves as a catalog or directory that maintains a record of all registered agents within the system, detailing the specific tools and functionalities that each agent possesses. By organizing agents according to their tools and capabilities, the agent registry enables efficient allocation of tasks, resource management, and deployment of agents based on their specialized functions. In an embodiment, the agent database 230 stores agent configurations, task assignments, performance metrics, and historical execution data.

In an embodiment, the security agent manager 200 determines the tasks that need to be executed based on a threat signal received from an external security system. In an embodiment, the security agent manager 200 breaks down a threat signal into tasks to remediate the potential threat indicated by the signal. In an embodiment, the security agent manager 200 executes a threat signal parsing function for extracting relevant information from the incoming threat signal. In an embodiment, the security agent manager 200 parses the threat signal and decodes the signal to identify key indicators of the potential threat or compromise, and/or attributes that may be further investigated. In an embodiment, the security agent manager 200 decodes the threat signal into various aspects, such as, for example, the type of threat, threat severity, and the affected system or network.

In an embodiment, the security agent manager 200 monitors the progress of each task based on feedback provided by each agent assigned to each respective task. Accordingly, the feedback provided to security agent manager 200 enables security agent manager 200 to perform further decision-making functions, such as for example, determining to assign and/or deploy another agent to accomplish a task, and/or configuring and training a new agent to accomplish a task, based on the progress and/or feedback received regarding the task. In an embodiment, security agent manager 200 evaluates the effectiveness of the remediation tasks performed by the worker agents, verifies whether the threat has been successfully mitigated, and assesses the overall response strategy. In an embodiment, the security agent manager 200 is configured to learn from historical data obtained from validating past remediation efforts, which enables the system to learn from past incidents and improve its response capabilities for future threats.

In an embodiment, the target system 210 may include various cyber threat security systems capable of generating threat signals. These systems may be configured to detect potential cyber threats and generate and transmit and alerts to the security agent manager 200 regarding potential security threats within the target system 210.

In an embodiment, the target system 210 includes a SIEM system. In an embodiment, the SIEM system within the target system 210 is designed to collect, analyze, and correlate security events to identify potential threats. In an embodiment, the SIEM system monitors network activity, log data, and system events to detect anomalies or suspicious behavior that may indicate a security breach. When the SIEM system identifies a potential threat, the SIEM system may generate a threat signal that is transmitted to the security agent manager module 200 for further analysis, evaluation, and response.

In an embodiment, the target system 210 includes an Endpoint Detection and Response (EDR) system configured for monitoring and securing individual endpoints, such as for example, computers, laptops, or mobile devices. In an embodiment, the EDR system may employ one or more known detection techniques to identify malicious activities, unauthorized access attempts, or unusual behavior on endpoints. When an EDR system detects a security threat, the EDR system generates a threat signal that is transmitted to the security agent manager module 200 for further analysis, evaluation and response.

In the illustrated embodiment, user device 220 includes a computing device configured to facilitate user interaction with the security agent manager module 200, thereby enabling a user to engage with the security investigation operations of the system. Accordingly, user device 220 may serve as an interface through which users can communicate instructions, commands, or requests to the security agent manager module 200, initiating security-related actions and overseeing the system's response to potential threats. Through user device 220, a user can access a user interface or application that allows the user to interact with the security agent manager module 200 over any suitable network 201. Users may input commands, configure security settings, view system alerts, monitor security events, or review investigation results through the interface provided by user device 220.

In an embodiment, user device 220 may support various communication channels, such as a graphical user interface (GUI), a command-line interface (CLI), a web-based portal, or a mobile application, depending on the system's design and user requirements. Users can communicate with the security agent manager module 200 in real-time, providing instructions for task assignments, requesting status updates on ongoing investigations, or receiving alerts on security incidents detected by the system.

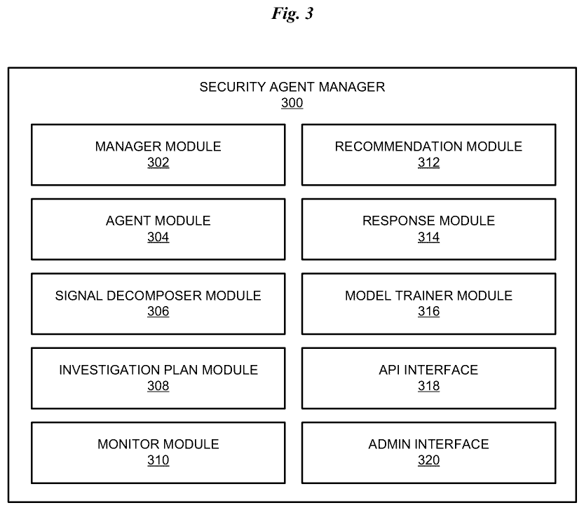

FIG. 3 depicts a block diagram of an example security agent manager software module 300 in accordance with an illustrative embodiment. In the illustrated embodiment, security agent manager module 300 is an example of security agent manager module 200 FIG. 2. In the illustrated embodiment, the security agent manager module 300 includes a software module including a plurality of other software modules, including a manager module 302, an agent module 304, a signal decomposer module 306, an investigation plan module 308, a monitor module 310, a recommendation module 312, a response module 314, a model trainer module 316, an API interface 318, and an administrator interface 320. In alternative embodiments, security agent manager module 300 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In some embodiments, the security agent manager module 300 comprises a physical computing device, including but not limited to, a general-purpose computer, a mainframe computer, a supercomputer, a quantum computer, a computer server, a personal computer, a laptop, a smartphone, a tablet, a personal digital assistant (PDA), etc., and any combination thereof. In some embodiments, the security agent manager module 300 comprises specialized hardware, such as for example, a Application-Specific Integrated Circuit (ASIC) or Field-Programmable Gate Array (FPGA) for accelerated processing of specific tasks, routines, algorithms, training operations, etc. In some embodiments, the security agent manager module 300 may include a combination of physical and virtualized components, as well as may be partially or entirely virtualized on a virtual machine.

In the illustrated embodiment, manager module 302 includes a software module that provides a manager agent. Accordingly, the manager module 302 may configure a manger agent to assign one or more tasks to one or more agents. In an embodiment, the manager module 302 employs one or more algorithms to match tasks with agents based on the agents'tooling, capabilities and/or availability.

In an embodiment, the manager module 302 triggers the deployment of one or more agents by the agent module 304 based on the tooling of each agent. Each agent within the multi-agentic system may be equipped with a specific tool optimized to perform a particular function. In an embodiment, the manager module 302 coordinates the deployment process by considering the capabilities and tooling of each agent to ensure tasks are assigned to the most suitable agents for execution. For instance, if a task involves data enrichment, the manager module 302 identifies the agent with the tool optimized for data enrichment and instructs the agent module 304 to deploy that specific agent for the task.

In the illustrated embodiment, the agent module 304 includes an agent registry that defines each agent registered within the system along with one or more tools corresponding to that agent. Accordingly, the agent registry may serve as a centralized database that stores information about each agent's capabilities and the tools associated with them, enabling efficient management and deployment of agents based on their specialized functions. When an agent is registered within the system, the agent registry captures details about the agent, including its unique identifier and the tools the agent possesses. Each agent may be associated with one or more tools that are specifically tailored to perform distinct functions relevant to security operations. In an embodiment, the agent module 304 includes an agent deployment module that causes one or more agents to be deployed to execute one or more tasks upon instruction by the manager module 302.

In the illustrated embodiment, the signal decomposer module 306 includes a software module configured to decompose an incoming threat signal into one or more attributes. Accordingly, the signal decomposer module 306 analyzes a received signal, extracts relevant information, and identifies specific attributes that may correspond to investigation tasks that need to be addressed. In an embodiment, the signal decomposer module 306 employs one or more algorithms and data analysis techniques to dissect the signal and identify key information, such as the type of threat, its severity, affected systems or endpoints, and any anomalous activities detected.

In an embodiment, the security agent manager 300 utilizes the signal decomposer module 306 to break down a signal received from an external security system, such as, for example, a Security Information and Event Management (SIEM) or Endpoint Detection and Response (EDR) system. When a signal is received via a data interface of the security agent module 300 from an external security system, the security agent manager 300 forwards the signal to the signal decomposer module 306 for processing. In an embodiment, the signal decomposer module is designed to interpret the signal, extract relevant data points, and identify signal attributes and/or indicators of potential security threats embedded within the signal.

In the illustrated embodiment, the investigation plan module 308 includes a software module that generates an investigation plan based on a threat signal received by the security agent manager 300. In an embodiment, the investigation plan module 308 generates an investigation plan based on attributes extracted from the threat signal received. In an embodiment, the actionable tasks are provided by the signal decomposer module 306. The investigation plan module 308 creates a structured plan outlining the sequence of tasks and strategies to investigate and respond to the security threat.

In an embodiment, the investigation plan module 308 generates an investigation plan that may be written in natural language using a Natural Language Processing (NLP) algorithm. The NLP algorithm processes the investigation plan and translates the tasks into human-readable descriptions, which likewise may be suitable for an LLM agent. Each task description may outline the specific actions to be executed and the objectives to be achieved in response to the security threat. In some embodiments, when the investigation plan module 308 formulates the investigation plan, the module may structure the tasks in a format that can be understood by both humans and machines.

For example, a task within the investigation plan may involve analyzing network traffic logs to identify anomalous patterns indicative of a potential security breach. The NLP algorithm translates this task into a natural language description, such as “Analyze network traffic logs to detect unusual patterns that may indicate a security threat.” When assigned the task, the agent leverages its NLP capabilities to interpret the human-readable description and perform the necessary actions. In this case, the agent module would analyze the network traffic logs, identify suspicious patterns, and report its findings back to the security agent manager or to another worker agent for further action.

In an embodiment, the output of one agent can be input to another agent in a coordinated manner to accomplish all tasks outlined in the investigation plan. The process involves the transfer of specific data output by the previous agent to the next agent, enabling a continuous flow of information and actions within the system. When an agent completes a task and generates output data, this information is transmitted to the next agent in the sequence as input. The input data may include relevant findings, analysis results, and/or actionable insights derived from the previous agent's task execution. By passing on this output data, the subsequent agent can build upon the insights gained and continue the investigation process.

In an embodiment, the output of the agent may be structured in natural language as an instruction for the next agent to carry out the task. The natural language instruction provides clear guidance on the actions to be taken, leveraging the insights and outcomes obtained from the previous agent's task which facilitates the transfer of information between agents. Accordingly, transforming an output into natural language formulation provides that the subsequent agent understands the context and objectives of the task based on the preceding agent's output.

In an embodiment, the natural language instruction of the task may include suggestions based on the previous output, which may guide the next agent on potential courses of action or areas of focus. The transfer of output data between agents in natural language format within the system promotes collaboration, information sharing, and knowledge transfer throughout the investigation process. In an embodiment, this coordinated approach provides that each agent builds upon the work of the previous agent, and leverages relevant execution related insights to collectively works towards achieving the objectives outlined in the investigation plan.

In an embodiment, the monitor module 310 actively tracks the progress of each agent within the system and communicates with the manager module 302 to adjust its deployment strategy based on the execution results throughout the investigation. The monitor module 310 continuously evaluates the performance of individual agents by monitoring task execution metrics, such as completion rates, response times, and accuracy of actions taken. As agents carry out assigned tasks, the monitor module 310 collects data on their performance and provides real-time feedback to the manager module 302. This feedback loop enables the manager module 302 to make informed decisions regarding task assignments, resource allocation, agent deployment, and further agent training if necessary. If the monitor module 310 detects any issues, delays, or inefficiencies in agent performance, the monitor module 310 may prompt the manager module 302 to modify the investigation plan and/or deployment strategy to address these challenges.

In the illustrative embodiment, the recommendation module 312 generates recommendations based on the execution of the investigation plan. This module analyzes the outcomes and results of the investigation process to provide actionable suggestions, insights, or guidance for remediating the present potential security threat and/or improving future security operations or response strategies. After the investigation plan is executed and tasks are completed by the agents, the recommendation module 312 analyzes the execution data to identify patterns, trends, anomalies, outliers, or areas for improvement within the security environment. In some embodiments, the recommendation module 312 formulates recommendations related to enhancing security measures, optimizing response protocols, or mitigating potential risks identified during the investigation. These recommendations may include suggestions for strengthening security controls, updating policies and procedures, implementing new technologies, or enhancing incident response strategies.

In the illustrative embodiment, the response module 314 is configured to automatically initiate one or more responsive actions based on the results of the investigation plan. In some embodiments, this module is designed to trigger predefined security responses, interventions, or countermeasures in real-time to address potential security threats identified during the investigation process. In an embodiment, upon completion of the investigation plan and analysis of the findings, the response module 314 evaluates the outcomes and determines the appropriate actions to be taken to prevent, mitigate, and/or remediate the identified security threats. Accordingly, the response module 314 may leverage the insights and recommendations generated during the investigation to guide its response strategy. Examples of security-related responses that may be activated may include, but are not limited to, isolating/quarantining compromised systems or subsystems to contain threats, deploying security patches to address vulnerabilities, locking down user accounts in response to suspicious activity, sending alert notifications to relevant parties, escalating incidents to response teams for further investigation, and initiating data backup and recovery procedures in case of data loss or corruption. In an embodiment, response module 314 may trigger model trainer module 316 to train a new agent or re-train an existing agent depending on the recommendation provided by the recommendation module 312 and/or instruction provided by manager module 302.

In the illustrated embodiment, the model trainer module 316 includes a software module configured to train one or more machine learning models described herein. In an embodiment, model training module 316 includes a data preparation module, an algorithm module, a training engine, and a machine learning model. In alternative embodiments, model training module 316 can include some or all of the functionality described herein but grouped differently into one or more modules.

In some embodiments, model trainer module 316 generates a machine learning model based on one or more known machine learning algorithms. In an embodiment, model trainer module 316 includes a training engine that trains machine learning model using training a dataset. In some embodiments, training dataset includes data related to a particular aspect of cybersecurity and threat detection. In an embodiment, training engine trains machine learning model using training dataset, resulting in trained machine learning model. In some embodiments, training dataset is divided into two discrete subsets, where one subset is used by training engine for initially training machine learning model and the other subset is used by the training engine to test trained model and determine the accuracy of trained model.

In some embodiments, the training dataset is pre-processed by a data preparation module for the model trainer. In some such embodiments, data preparation module structures the data to make best use of machine learning model. Embodiments of data preparation module use one or more of the following heuristics. Linear data transformation: transform the data to make the relationship linear (e.g., log transform for an exponential relationship). Noise reduction: use data cleaning operations that better expose and clarify the signal in the data, e.g., remove outliers in the output variable (y) where possible. Collinearity reduction: calculate pairwise correlations for the input data and remove the most correlated to prevent over-fitting of the data due to highly correlated input variables. Gaussian distribution: transform the input data (e.g., logarithmic or Box-Cox transformation) so that input and output variables have a Gaussian distribution. Rescale Inputs: scale data using normalization (e.g., rescale data so that values are within a range of 0 and 1) or standardization (e.g., rescale data so that the mean of observed values is 0 and the standard deviation is 1).

In an embodiment, the training data generation process includes collecting and analyzing historical interaction data to identify instances where execution results indicated a task was successfully completed. Training instances may be dynamically created depending on the functionality needed by a security agent. To account for the diverse needs and characteristics of different aspects of security investigation, a separate model may be established and/or trained for each specific type of task to be executed related to threat investigation. Additionally, meta-learning and/or transfer learning techniques may be employed to train a model for a particular application, and then may be adapted for other similar applications. Accordingly, it is contemplated herein that this approach enhances the model's ability to generalize across different segments and territories, improving its predictive accuracy and efficiency. In an embodiment, the model trainer module processes historical data, fine-tunes algorithms and/or model parameters, and optimizes model performance based on predefined goals and/or criteria, as discussed in greater detail herein.

In an embodiment, the model trainer module 316 is responsible for training an agent to perform a specific function using a designated tool within the multi-agentic system framework described herein. Accordingly, this module facilitates the development of agent capabilities by providing structured training programs and learning opportunities to enhance an agent's proficiency in executing specialized tasks. When a new agent is introduced to the system or when an existing agent needs to acquire additional skills for a specific function, the model trainer module 316 initiates the training process. The module designs and implements training programs tailored to the function the agent is expected to perform and the tool it will utilize for task execution.

Further, training an agent for a security-related function may involve leveraging various types of training data to enhance the agent's capabilities. Historical security incident data provides insights into past security incidents, breaches, and vulnerabilities, enabling agents to recognize patterns and common attack vectors. Anomalous behavior data, such as unusual network traffic patterns and abnormal user activities, helps agents detect and respond to suspicious behavior indicative of security threats. Security logs and event data provide information on system activities and network events, allowing agents to correlate events and identify security incidents. Threat intelligence feeds may contain information on emerging threats and known vulnerabilities keep agents updated on the latest security risks, allowing an agent to proactively defend against potential attacks. Simulated attack scenarios and penetration testing data may help train agents to recognize and respond to various cyber threats, enhancing their incident response capabilities. User behavior analytics data enables agents to detect insider threats and unauthorized access by analyzing user behavior, access patterns, and privilege usage. By incorporating diverse training data sources, agents can develop the knowledge and skills needed to effectively address security threats and protect the system from potential risks.

In the illustrated embodiment, the application programming interface module 318 serves as the interface through which users and/or applications interact with the manager module 302 and/or agents orchestrated by the security agent manager 300 and facilitates the exchange of information between the users and/or applications and these modules. In an embodiment, the application programming interface module 318 is configured to interact with any or all other modules within the application to relay user input and queries, receive output execution results and responses, and provide feedback on the effectiveness of the system in adhering to the investigation plan. In some embodiments, security agent manager 300 connects with API gateway via any suitable network or combination of networks such as the Internet, etc. and uses any suitable communication protocols such as Wi-Fi, Bluetooth, etc. to connect to external systems required to access to perform certain tasks. Further, the API gateway may transmit service requests received from a client interacting with security agent manager 300.

In the illustrated embodiment, administrative module 320 allows users with administrative privileges to perform various administrative tasks associated with security agent manager module 300 as described herein. For example, in some embodiments, administrative user device 320 allows a user with administrative privileges to initiate a data collection process or network monitoring process. As another example, in some embodiments, administrative user device 320 allows a user with administrative privileges to initiate and monitor the training process performed by model training module 316, including setting desired parameters and/or hyperparameters for the training process.

In an embodiment, administrative module 320 includes a user interface configured to allow a user having sufficient privileges to oversee the operation and management of the multi-agentic system. In an embodiment, administrator module 320 controls access permissions, monitors system performance, and handles any administrative tasks related to the platform. In an embodiment, the administrator module 320 interacts with any or all other modules to promote compliance with the administrative settings. Further, a backend administration system allows users with administrative privileges to perform various administrative tasks associated with the security agent manager module as described herein, such as initiating a data collection and/or correlation process, a neural network training process, defining optimization goals, defining execution parameters/criteria, defining an agent, and any other defined settings discussed herein.

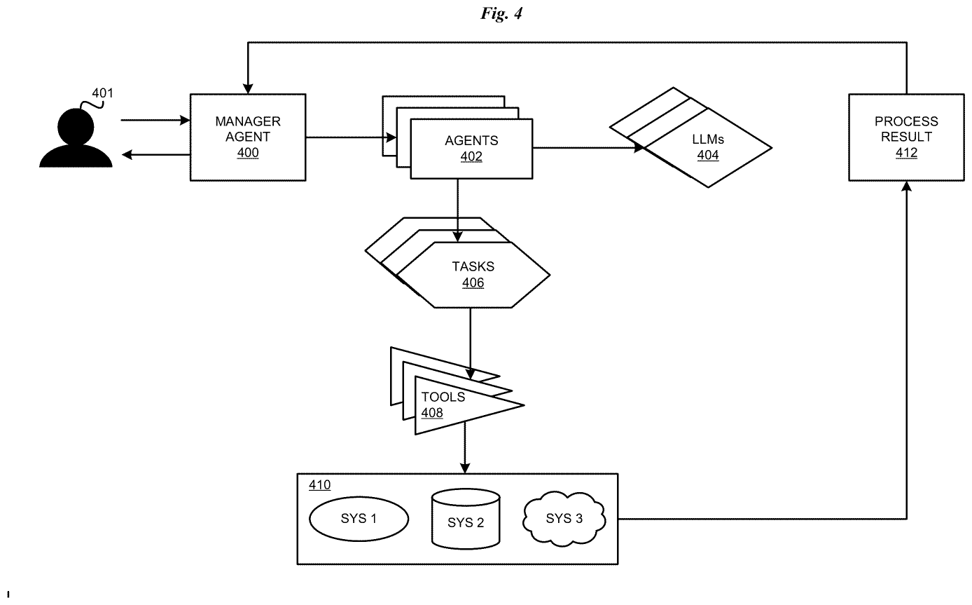

FIG. 4 depicts a block diagram of an example multi-agentic system in accordance with an illustrative embodiment. In the illustrated embodiment, manager agent 400 includes security agent manager module 200 of FIG. 1 and FIG. 2 and/or security agent manager module 200 of FIG. 3.

In the illustrated embodiment, a user 401 is shown interacting with manager agent 400. In an embodiment, the user 401 may input a command to the manager agent 400 to generate an investigation plan to investigate a potential security threat. In an embodiment, the user 401 inputs a threat signal received from an external security device or system, and the manager agent 400 generates an investigation plan in response to analyzing the security threat signal.

In the illustrated embodiment, the manager agent 400 assigns one or more agents 402 to complete the one or more tasks 406. In an embodiment, the one or more tasks are defined and outlined in an investigation plan generated by the manager agent 400. In an embodiment, the manager agent 400 assigns agents 402 to tasks 406 based on the available tooling of each agent. In an embodiment, the manager agent 400 determines the tools necessary to accomplish each task of the investigation plan and assigns agents to tasks by matching agents with tasks via an agent registry, such that the agent registry defines each agent of the set of agents 402 with one or more tools possessed the agent.

In an embodiment, the manager agent 400 may determine that there is not an agent configured with the tools necessary to accomplish a particular task of the investigation plan. In such a scenario, the manager agent 400 may determine what tool or tools are needed to be able to accomplish an unassigned task in the investigation plan. Upon a determination of the necessary tool required by an agent to be able to accomplish the unassigned task, the manager agent may initiate a configuration and training process to configure and train a new agent with a new tool to accomplish the previously unassigned task. In an embodiment, once the manager agent 400 determines that each task can be accomplished using the available agents (including the new agent), the manager agent 400 assigns agents to tasks by matching agents with tasks via an agent registry. In some embodiments, the manager agent 400 may assign agents to tasks without necessarily waiting for a new agent to be configured to be able to accomplish one or more unassigned tasks.

In the illustrated embodiment, the one or more agents 402 employs one or more tools 408 to accomplish the one or more tasks 406. In an embodiment, each tool of tools 408 may be specifically designed for a type of task, and/or for a specific system or subsystem component depicted by block 410. In the illustrated embodiment, process results 412 are obtained from executing one or more functions using one or tools 408 to accomplish the one or more tasks 406.

In an embodiment, the interaction between user 401 and manager agent 400 initiates the execution of tasks within the multi-agentic system. In some embodiment, user 401 may provide instructions to manager agent 400, directing manager agent 400 to perform specific tasks or a sequence of tasks aligned with an investigation plan. The manager agent 400, acting as an orchestrator, assigns the identified tasks to one or more agents 402 within the system. The agents 402, equipped with specialized tools 408, leverage their capabilities to execute the assigned tasks 406 effectively. Agents 402 use these tools to perform functions and produce process results 412, such that the process results 412 reflect task completion (or lack thereof) and as well as any relevant contextual data, derived insights, and/or further recommendations.

In the illustrative embodiment, the process results 412 are forwarded to the manager agent 400. In the illustrated embodiment, the manager agent 400 modifies the deployment of one or more agents 402 depending on the process results 412. In an embodiment, the modification to the deployment may include selecting an additional agent to deploy, terminating an existing agent that is currently deployed, or both. In an embodiment, the manager agent 400 actuates a training process to train new agent if the existing agents 402 do not possess the appropriate tools and/or functions necessary to accomplish a portion of the tasks 406.

In the illustrated embodiment, each agent of agents 402 may be configured with a different large-language model (LLM) of LLMs 404. In an embodiment, the selection of the LLM for each agent is based on the effectiveness of that LLM in enabling the agent to accomplish a specific task that the agent is designed to be able to execute. In an embodiment, the training data used to train each LLM of LLMs 404 may be different, resulting in a different uniquely configured neural network.

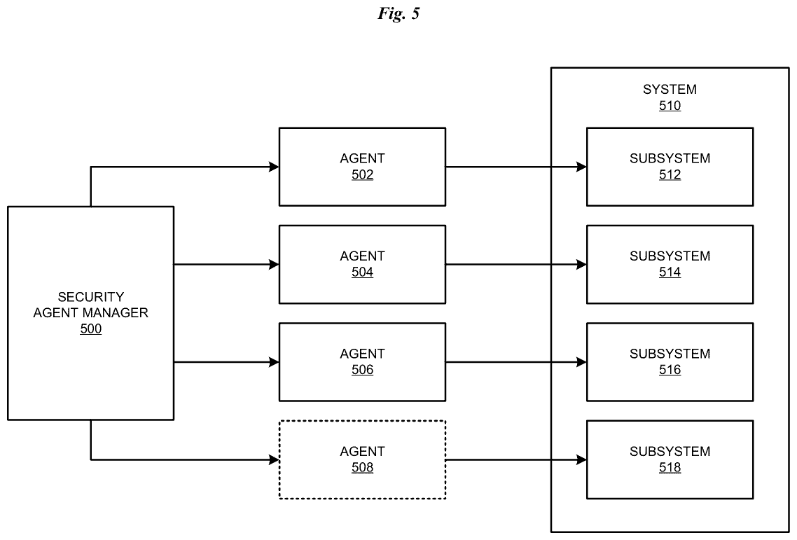

FIG. 5 depicts a block diagram of an example process for automated threat investigation in accordance with an illustrative embodiment. In the illustrated embodiment, aspects of the depicted process may be executed in whole or in part by security agent manager module 200 of FIG. 1 and FIG. 2, security agent manager module 300 of FIG. 3, and/or manager agent 400 of FIG. 4

In the illustrated embodiment, the security agent manager 500 orchestrates the deployment of multiple agents, including the first agent 502, second agent 504, and third agent 506, to perform specified actions across system 510. Each agent may be equipped with a distinct tool tailored to perform specific functions, contributing to the comprehensive security operations of the system. For instance, the first agent 502 may be specialized in enrichments, enhancing data quality and context for analysis. The second agent 504 may be specialized for extractions, extracting relevant information from various data sources for further processing. The third agent 506 may specialize in machine learning, utilizing algorithms to detect patterns and anomalies in system behavior.

In the illustrated embodiment, the first agent 502 is assigned to perform a function related to the first subsystem 512 of system 510. This could involve tasks such as data enrichment, normalization, or data quality checks within the subsystem. The second agent 504 is tasked with executing a function associated with the second subsystem 514, which may include data extraction, log analysis, or threat detection specific to that subsystem. The third agent 506 is responsible for performing a function related to the third subsystem 516, such as contextualizing security events, correlating data points, or identifying relationships between security incidents.

For example, suppose the first agent 502 is configured for data enrichment and thereby may enhance raw data with additional context or metadata to facilitate analysis. The second agent 504 configured for extractions may extract relevant indicators of compromise or security events from log files or network traffic. The third agent 506 agent may utilize algorithms to detect anomalies, classify threats, or predict potential security incidents based on historical data. Each agent's specialized function contributes to the overall security posture of the system by addressing specific aspects of data analysis, threat detection, incident response, and within their respective subsystems.

In an embodiment, each subsystem of system 510 may require unique permission settings to access. In such embodiments, each agent may possess the requisite permissions to access a particular subsystem. Further, each agent may be equipped with the proper API to enable the agent to access a particular subsystem of system 510. For example, the first agent 502 may possess the required access permissions and/or API to access the first subsystem 512, the second agent 504 may possess the required access permissions and/or API to access the second subsystem 514, and the third agent 506 may possess the required access permissions and/or API to access the first subsystem 512. In some embodiments, each agent may only comprise access permissions for a single subsystem. In some other embodiments, one or more agents may comprise access permissions for multiple subsystems.

In an embodiment, in an instance where the manager agent 500 determines that additional agents are required to accomplish tasks in the investigation plan, the manager agent 500 may initiate an agent creation, configuration, and training process. In this scenario, the manager agent 500 may deploys the first agent 502, the second agent 504, and the third agent 506 to work on the assigned tasks corresponding to subsystem 512, 514, and 516, respectively. However, there is not yet an agent that possesses the appropriate tooling to be able to interact with the fourth subsystem 518 to accomplish a fourth task of the investigation plan. In an embodiment, the manager agent 500 initiates creating a new agent 508 to fulfill the requirements of the investigation plan. The new agent creation process may include creating a new agent data structure, generating a new agent profile, assigning necessary permissions, and initializing the agent with the system. After the fourth agent 508 is created and configured, the manager agent 500 assigns specific tasks from the investigation plan to this new agent, which none of the previous agents 502, 504, and 506 were capable of accomplishing.

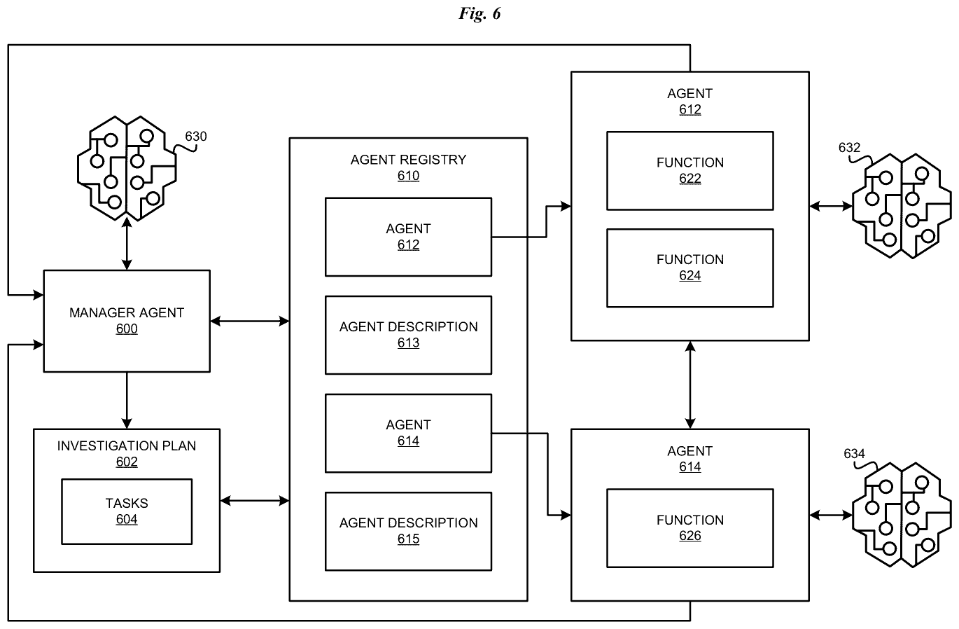

FIG. 6 depicts a block diagram of an example process for automated threat investigation in accordance with an illustrative embodiment. In the illustrated embodiment, aspects of the depicted process may be executed in whole or in part by security agent manager module 200 of FIG. 1 and FIG. 2, security agent manager module 300 of FIG. 3, manager agent 400 of FIG. 4, and/or security agent manager 500 of FIG. 5.

In the illustrated embodiment, the manager agent 600 initiates the process by dynamically generating an investigation plan 602 tailored to an incoming security alert. In an embodiment, the investigation plan 602 may be customized based on the origin of the alert, varying for alerts originating from different systems or security devices. In an embodiment, the dynamic generation of the investigation plan may be contingent upon the type of alert received by the system. In an embodiment, when a security alert is triggered, the system may transmit the alert to the manager agent 600 that proceeds to analyze the characteristics and attributes of the alert. Based on this analysis, the manager agent 600 dynamically generates an investigation plan 602 that is specifically tailored to address the unique aspects of the alert.

In an embodiment, upon generation of investigation plan 602, the manager agent 600 systematically progresses through the investigation plan, assigning each step to a designated agent for execution. In an embodiment, the investigation plan 602 includes a set of tasks to complete. In an embodiment, each task of the set of tasks 604 of the investigation plan 602 corresponds to one or more attributes extracted from a threat signal received by the manager agent 600. Once a threat signal is received and broken down into attributes and further transformed into specific tasks, the security agent manager 600 assesses the capabilities and functions of the available security agents to accomplish each of the tasks. Accordingly, each security agent may be programmed with specific functions and expertise to address different aspects of security threats. If there is a security agent available that is capable of performing the tasks required to remediate the threat indicated by the signal, the security agent manager 600 may assign the task(s) to that agent.

In the context of signal processing within a cybersecurity framework, signals or other telemetry data may be analyzed by leveraging the LLM of the manager agent 600 to extract specific attributes that provide valuable insights into the nature of the security incident. Some examples of attributes that may be identified in a signal may include, but are not limited to, IP addresses and command line hash values. Accordingly, these and other attributes may serve as components for understanding and categorizing the incoming signals, enabling agents to perform targeted analysis and response actions based on the extracted attributes. In an embodiment, agents within the multi-agentic system are equipped to process each attribute individually. Accordingly, each attribute may serve as a data point that informs the agent's decision-making process and guides the appropriate response actions based on the unique characteristics of the signal.

In the illustrated embodiment, the manager agent 600 assigns tasks by matching agents to tasks via an agent registry 610. In an embodiment, the agent registry 610 defines an agent according to an agent description. As depicted, a first agent 612 is shown corresponding to a first agent description 613 and a second agent 614 is shown corresponding to a second agent description 615. In an embodiment, each agent description may indicate the available tools, functions, and/or capabilities of a particular agent. Accordingly, as depicted, the first agent 612 is equipped with a first function 622 and a second function 624, and the second agent 614 is equipped with a third function 626. In an embodiment, defining an agent within the multi-agentic system involves specifying the agent's role, responsibilities, and objectives to effectively contribute to the system's operations. This definition outlines what the agent is supposed to do within the system, clarifying its function, purpose, and scope of activities. By defining the agent's function, the manager agent 600 can establish clear expectations and guidelines for the agent's role in supporting security operations or other system functions.

In an embodiment, defining an agent includes identifying all the tasks that the agent is capable of performing based on its design, tooling, functions, capabilities, and expertise. By detailing the agent's capabilities, the system gains insights into the agent's areas of specialization, enabling effective task assignment and resource allocation based on the agent's competencies. In an embodiment, defining an agent involves listing the tools and resources available for the agent to utilize in executing its tasks. This may include identifying the software components, algorithms, data sources, or external systems that the agent can leverage to enhance its performance and achieve its objectives. By specifying the tools available to the agent, the system ensures that the agent has access to the necessary resources to carry out its tasks.

In the illustrated embodiment, the manager agent 600 is shown assigning the first agent 612 and the second agent 614 to different tasks. For example, suppose the investigation plan 602 includes determining the severity of a potential security threat. To accomplish this step of the investigation, the task assigned to the first agent 612 may include command line analysis, and the task assigned to the second agent 614 may include assigning a risk rating to an incoming alert. In this case, the second agent 614 may await completion of data processing from the first agent 612 designated for analyzing command lines. Once the first agent 612 completes its command line analysis, the first agent 612 forwards the results to second agent 614 for further risk assessment and assignment of a risk rating. Accordingly, agents may be instructed to receive specific information from designated sources, including other agents, and utilize this data for further analysis as per predefined task of the investigation plan 602.

In an embodiment, the first agent 612 leverages a first trained LLM 632 and the second agent 614 leverages a second trained LLM 634. In an embodiment, each LLM is different from each other. In an embodiment, each LLM has been trained on different training data from each other. In an embodiment, the manager agent 600 comprises an LLM 630 specifically trained to generate investigation plan 602 based on attributes corresponds to a decomposed threat signal.

In an embodiment, in an event that there is no presently available security agent module that can perform the functions required to accomplish a specific task, the security agent manager 600 may initiate a training process to equip a new agent with the necessary capabilities. The training process may include identifying the specific functions and expertise required to accomplish the task indicated by the threat signal. In an embodiment, the new agent is trained using any combination of simulations, data analysis exercises, and real-time scenarios to enable the agent to effectively perform one or more specific tasks. In an embodiment, security agent manager 600 monitors the agent's progress and adjusts the training process as necessary to ensure agent is being trained effectively.

In an embodiment, once the new agent has been trained, the new agent may be integrated into the multi-agentic system and may be assigned the task originally identified by the threat signal. In an embodiment, the security agent manager monitors the performance of the new agent and evaluates the new agent's effectiveness in executing the task. This adaptive training approach enhances the system's flexibility and responsiveness to evolving security threats. Accordingly, embodiments of the present disclosure may be designed to be adaptable and capable of handling unknown or new security events that have not previously encountered.

In an embodiment, when the manager agent 600 identifies a task for which no existing agent is registered, the manager agent 600 initiates a dynamic learning process to generate a new agent. In an embodiment, the security agent manager ingests and analyzes relevant documentation, such as for example, security device manuals, API documentation, vendor-specific threat intelligence reports, and other technical resources related to an originating security system. In an embodiment, the security agent manager agent also searches external sources for relevant information, such as for example, cybersecurity forums, publicly available documentation, and user discussions from sources or other specialized knowledge bases. Using this gathered information, the manager agent determines how the new task should be performed and constructs an API call or other method for obtaining necessary data. In an embodiment, the security agent manager generates a new agent such that the new agent is provided with a structured set of tools that enable the new agent to execute the required task, and is further assigned to execute the required task. Dynamic agent creation enables real-time adaptation to emerging threats and seamless integration with new security technologies without requiring manual intervention.

In an embodiment, each agent includes an interface component that enables the agent to communicate with various external systems and interfaces to fetch information, process data, receive recommendations, and implement actions. The interface component facilitates communication between the agent and different components such as LLM, a repository, a cloud API, a conversational interface, a search engine, and so forth.

In an embodiment, an agent may interact with the LLM to fetch information and process data. The agent sends queries or requests to the LLM, which utilizes natural language processing techniques to understand and respond to the agent's inquiries. The LLM provides relevant information or insights based on the input received from the agent, enabling the agent to make informed decisions or take appropriate actions. In an embodiment, the agent interacts with a conversational interface to engage in dialogues and receive input from users or other agents. The conversational interface allows the agent to communicate in a natural language format, enabling seamless interactions and exchanges of information. The agent can receive instructions, feedback, or recommendations through the conversational interface, enhancing its ability to collaborate and coordinate with other entities.

In an embodiment, the agent may interact with a search engine to retrieve relevant information from the web or internal databases. The agent can submit search queries to the search engine, which then returns results based on the search terms provided. By leveraging the search engine, the agent can access a vast amount of information available online or within organizational databases to support its decision-making processes. In an embodiment, the agent interacts with a repository to access stored data and information. The agent can query the repository to retrieve specific data sets, documents, or files needed for analysis or decision-making. The repository serves as a centralized storage system that houses relevant information that the agent can leverage to perform its tasks efficiently.

In an embodiment, the agent may interact with a cloud API to access cloud-based services and resources. The agent can make API calls to cloud services for tasks such as data storage, computation, or machine learning capabilities. By leveraging cloud APIs, the agent can access scalable and flexible resources to enhance its functionality and performance.

In an embodiment, the agent can receive recommendations from the agent manager based on analysis or predefined criteria. The agent manager evaluates the agent's performance, data insights, or external factors to provide recommendations on potential actions or strategies. The agent can implement these recommendations by executing specific tasks, adjusting parameters, or initiating actions on designated targets to achieve desired outcomes.

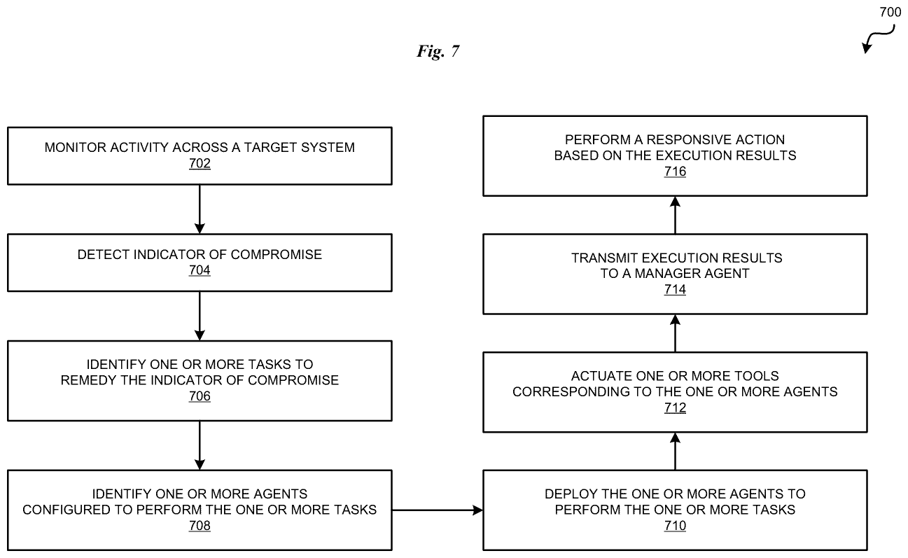

FIG. 7 depicts a flowchart of an example process for automated security threat investigation. In an embodiment, security agent manager module 200 of FIGS. 1 and 2, security agent manager module 300 of FIG. 3, manager agent 400 of FIG. 4, manager agent 400 of FIG. 4, security agent manager 500 of FIG. 5, and/or manager agent 600 of FIG. 6 carries out some or all of the steps of process 700.

In an embodiment, at block 702, the process monitors activity across a target system. In an embodiment, at block 704, the process detects an indicator of compromise. In an embodiment, the process detects an indicator of compromise based on the data collected during monitoring activity across the target system. In an embodiment, at block 706, the process identifies one or more tasks to remedy the indicator of compromise detected. In an embodiment, at block 708, the process identifies one or more agents configured to perform the one or more tasks. In an embodiment, at block 710, the process deploys the one or more agents to perform the one or more tasks. In an embodiment, at block 712, the process actuates one or more tools corresponding to the one or more agents to perform the one or more tasks. In an embodiment, at block 714, the process transmits execution results corresponding to the performance of the one or more tasks by the one or more agents using the one or more tools to the manager agent. In an embodiment, at block 716, the process performs one or more responsive actions based on the execution results received by the manager agent.

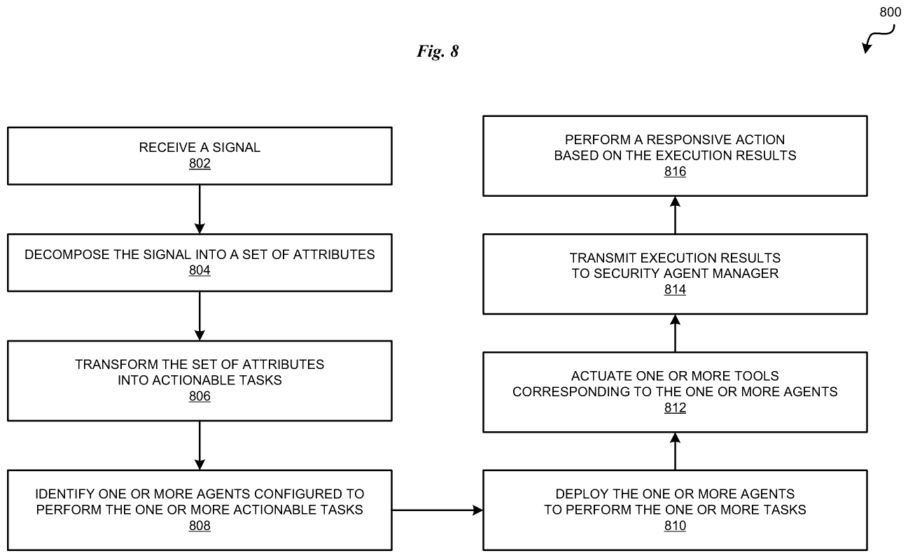

FIG. 8 depicts a flowchart of an example process 800 for automated threat investigation. In an embodiment, security agent manager module 200 of FIGS. 1 and 2, security agent manager module 300 of FIG. 3, manager agent 400 of FIG. 4, manager agent 400 of FIG. 4, security agent manager 500 of FIG. 5, and/or manager agent 600 of FIG. 6 carries out some or all of the steps of process 800.

In an embodiment, at step 802, the process receives a signal. In an embodiment, the signal includes a cyber threat-related signal. In an embodiment, the cyber-threat signal is received from cyber security monitoring system. In an embodiment, at step 804, the process decomposes the signal into a set of attributes. In an embodiment, at step 806, the process transforms the set of attributes into actionable tasks.

In an embodiment, at step 808, the process identifies one or more agents configured to perform the one or more actionable tasks. In an embodiment, the process includes establishing an agent registry, such that the agent registry defines a set of agents according to their respective tools, functions, and/or capabilities. In an embodiment, identifying the one or more agents configured to perform the one or more actionable tasks includes comparing and matching tools identified that are required to accomplish one or more tasks of the investigation plan to agents that are configured with said tools.

In an embodiment, at step 810, the process deploys one or more agents to perform the one or more actionable tasks. In an embodiment, at step 812, the process actuates one or more tools belonging to the one or more agents to perform the one or more actionable tasks.

In an embodiment, at step 814, the process transmits the execution results to a centralized security agent manager. In an embodiment, at step 816, the process performs a responsive action based on the execution results. In an embodiment, the responsive action includes modifying the investigation plan based on the execution results. In an embodiment, the modifying the investigation plan may include modifying the assignment of agents to tasks. In an embodiment, the responsive action may include training a new agent to perform a previously existing or new task, and assigning the new agent to the selected task.

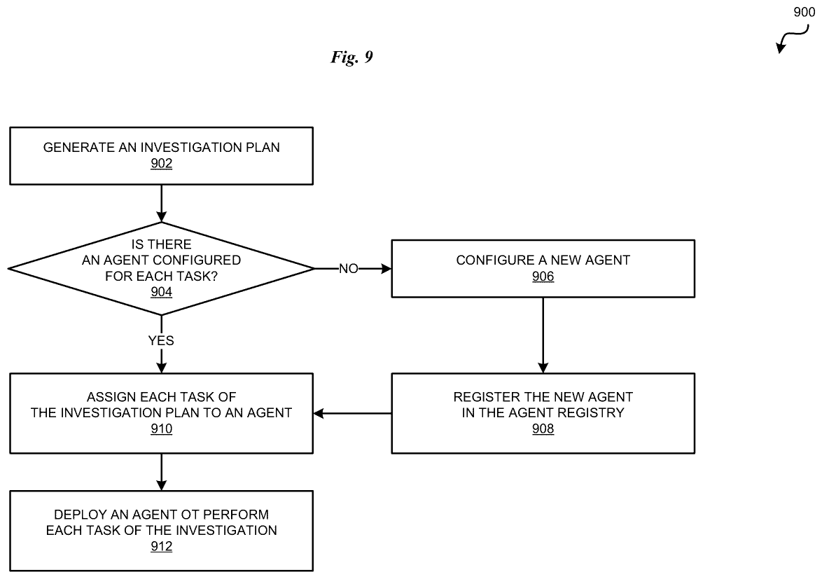

FIG. 9 depicts a flowchart of an example process 900 for dynamic agent assignment and creation. In an embodiment, security agent manager module 200 of FIGS. 1 and 2, security agent manager module 300 of FIG. 3, manager agent 400 of FIG. 4, manager agent 400 of FIG. 4, security agent manager 500 of FIG. 5, and/or manager agent 600 of FIG. 6 carries out some or all of the steps of process 900.

In an embodiment, at step 902, the process generates an investigation plan. In an embodiment, at step 904, the process determines whether there is an agent configured to be able to execute each task of the investigation plan. In an embodiment, upon a determination that each task of the investigation plan may be accomplished by one or more agents, the process proceeds to step 910. In an embodiment, upon a determination that there is not at least one agent capable of executing at least one task of the investigation plan, the process proceeds to step 906. In an embodiment, at step 906, the process configures a new agent. In an embodiment, the process configures the new agent with the necessary tooling, permissions, training, and so forth to be able to execute the previously un-assignable task of the investigation plan. In an embodiment, at step 908, the process registers the new agent in the agent registry. In an embodiment, at step 910, the process assigns each task of the investigation plan to a respective agent. In an embodiment, at step 912, each agent assigned to a task is deployed to execute their respective task.

Although the present disclosure discusses cybersecurity threat investigations as an illustrative example application of the disclosed multi-agentic system, it is understood that the system described herein may extend beyond cybersecurity applications to other domains requiring complex multi-step investigations. The AI manager dynamically organizes these investigative workflows, and orchestrates deployment of specialized agents to handle each aspect of a workflow. Some example use-cases and alternative embodiments of the present disclosure are provided below.

In a particular instance, an embodiment of the present disclosure may be adapted for vacation planning. For example, in an embodiment, the signal decomposer module of the autonomous agent manager application is configured to decompose a command signal that includes a command to plan a vacation into a set of attributes relevant to planning a vacation. These attributes extracted from the command signal may include, but are not limited to, the destination, travel dates, preferred activities, budget constraints, accommodation preferences, transportation mode, and any special requirements, constraints, preferences and/or requests specified in the command signal.

Further, an embodiment of the present disclosure may be configured to transform these attributes a set of actionable tasks. These tasks may include, but are not limited to, researching travel options, booking accommodations, creating an itinerary, arranging transportation, and making reservations for activities and attractions. Further, an embodiment of the present disclosure may be configured to generate an action plan based on the set of actionable tasks derived from the attributes extracted from the command signal. Further, an embodiment assigns a set of AI agents with the necessary expertise to execute the tasks outlined in the vacation action plan. In an embodiment, a separate agent comprising the appropriate tooling may be assigned to execute each task of the action plan, such as for example, a first agent configured to perform relevant research, a second agent to perform booking a hotel, a third agent for generating an itinerary, and so forth.

In a particular instance, an embodiment of the present disclosure may be adapted for stock market investing. For example, in an embodiment, the signal decomposer module of the autonomous agent manager application is configured to decompose a command signal that includes a command to invest money into the stock market into a set of attributes relevant to investing into the stock market. These attributes extracted from the command signal may include, but are not limited to, the investment amount, risk tolerance level, investment goals (e.g., short-term gains, long-term growth), preferred sectors or industries, specific stocks or funds of interest, and any special requirements, constraints, preferences and/or requests specified in the command signal.

Further, an embodiment of the present may be configured to transform these attributes into a set of actionable tasks. These tasks may include, but are not limited to, conducting market research, analyzing stock performance, diversifying the investment portfolio, monitoring market trends, and executing buy or sell orders based on the investment strategy outlined in the command signal. Further, an embodiment of the present disclosure may be configured to generate an action plan based on the set of actionable tasks derived from attributes extracted from the command signal. Accordingly, the action plan may outline the sequence of steps to be taken to invest the specified amount of money in the stock market. Further, an embodiment assigns a set of AI agents with the necessary expertise to execute the tasks outlined in the action plan. In an embodiment, a separate agent comprising the appropriate tooling may be assigned to execute each task of the action plan, such as, for example, a first agent configured to perform conducting market research, a second agent configured to perform analyzing stock performance, a third agent configured to perform executing buy or sell orders based on the investment strategy, and so forth.

In a particular instance, an embodiment of the present disclosure may be adapted for health and fitness planning. For example, in an embodiment, the signal decomposer component of the autonomous agent manager application is configured to decompose a health report that includes biometric data and a command to create a personalized health and fitness plan into a set of attributes relevant to health and wellness. These attributes extracted from the health report may include, but are not limited to, biometric data such as blood pressure, cholesterol levels, heart rate, body mass index (BMI), glucose levels, and other relevant health markers. Additionally, the attributes may include the individual's health goals (e.g., weight loss, muscle gain, cardiovascular improvement), dietary preferences, exercise limitations, specific health conditions, and any special requirements, constraints, preferences, and/or requests specified in the health report.

Further, an embodiment of the present disclosure may be configured to transform these attributes into a set of actionable tasks. These tasks may include, but are not limited to, generating a personalized meal plan, designing a customized exercise routine, providing coaching and motivation, setting health targets, monitoring progress, and adjusting the plan based on the individual's biometric data and health goals. Further, an embodiment of the present disclosure may be configured to generate an action plan based on the set of actionable tasks derived from attributes extracted from the health report. Accordingly, the action plan may outline the sequence of steps to be taken to improve the individual's biomarkers and overall well-being, considering specific health markers, goals, and preferences mentioned in the health report. Further, an embodiment assigns a set of AI agents with the necessary expertise to execute the tasks outlined in the health and fitness action plan. In an embodiment, a separate agent comprising the appropriate tooling may be assigned to execute each task of the action plan, such as, for example, a first agent configured to perform generating a personalized meal plan, a second agent configured to perform designing a customized exercise routine, a third agent configured to perform providing coaching and motivation, and so forth.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
decomposing within a decomposition module of a security agent manager application a signal into a set of attributes, the signal being received at a data input interface of the security agent manager application;
generating within an investigation plan module of the security agent manager application an investigation plan based on the set of attributes, the investigation plan comprising a set of actionable tasks;
identifying within an agent registry module of the security agent manager application a first agent capable of executing a first task of the set of actionable tasks;
assigning within an agent deployment module of the security agent manager application the first agent to the first task, the assigning causing executing, by the first agent, the first task, the executing the first task producing a first execution result; and
performing within a response module of the security agent manager application, upon receiving the first execution result at the data input interface of the security agent manager application, a responsive action, the responsive action based on the first execution result.

2. The computer-implemented method of claim 1, further comprising:
determining within the agent registry module of the security agent manager application that there is no agent capable of executing at least one task of the set of actionable tasks; and
training within a model trainer module of the security agent manager application a new agent, the training the new agent causing the new agent to be capable of executing the at least one task.

3. The computer-implemented method of claim 1, further comprising:
identifying within the agent registry module of the security agent manager application a second agent capable of executing a second task of the set of actionable tasks; and
assigning within the agent deployment module of the security agent manager application the second agent to the second task, the assigning causing executing, by the second agent, the second task, the executing the second task producing a second execution result.

4. The computer-implemented method of claim 3, wherein the executing, by the second agent, the second task, is based on the first execution result.

5. The computer-implemented method of claim 3, wherein the executing, by the first agent, the first task and the executing, by the second agent, the second task, is performed in parallel.

6. The computer-implemented method of claim 1, wherein each of a set of agents comprises a uniquely trained neural network.

7. The computer-implemented method of claim 1, wherein the performing within the response module of the security agent manager application the responsive action comprises generating within the investigation plan module of the security agent manager application an updated investigation plan.

8. The computer-implemented method of claim 1, wherein the performing the responsive action comprises assigning within the agent deployment module of the security agent manager application a third agent to a third task, the assigning causing executing, by the third agent, the third task, the executing the third task producing a third execution result.

9. A computer program product comprising one or more computer readable storage media, and program instructions collectively stored on the one or more computer readable storage media, the program instructions executable by a processor to cause the processor to perform operations comprising:
decomposing within a decomposition module of a security agent manager application a signal into a set of attributes, the signal being received at a data input interface of the security agent manager application;
generating within an investigation plan module of the security agent manager application an investigation plan based on the set of attributes, the investigation plan comprising a set of actionable tasks;
identifying within an agent registry module of the security agent manager application a first agent capable of executing a first task of the set of actionable tasks;
assigning within an agent deployment module of the security agent manager application the first agent to the first task, the assigning causing executing, by the first agent, the first task, the executing the first task producing a first execution result; and
performing within a response module of the security agent manager application, upon receiving the first execution result at the data input interface of the security agent manager application, a responsive action, the responsive action based on the first execution result.

10. The computer program product of claim 9, wherein the stored program instructions are stored in a computer readable storage device in a data processing system, and wherein the stored program instructions are transferred over a network from a remote data processing system.

11. The computer program product of claim 9, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

12. The computer program product of claim 9, further comprising:
determining within the agent registry module of the security agent manager application that there is no agent capable of executing at least one task of the set of actionable tasks; and
training within a model trainer module of the security agent manager application a new agent, the training the new agent causing the new agent to be capable of executing the at least one task.

13. The computer program product of claim 9, further comprising:
identifying within the agent registry module of the security agent manager application a second agent capable of executing a second task of the set of actionable tasks; and
assigning within the agent deployment module of the security agent manager application the second agent to the second task, the assigning causing executing, by the second agent, the second task, the executing the second task producing a second execution result.

14. The computer program product of claim 13, wherein the executing, by the second agent, the second task, is based on the first execution result.

15. The computer program product of claim 13, wherein the executing, by the first agent, the first task and the executing, by the second agent, the second task, is performed in parallel.

16. The computer program product of claim 9, wherein each of a set of agents comprises a uniquely trained neural network.

17. The computer program product of claim 9, wherein the performing within the response module of the security agent manager application the responsive action comprises generating within the investigation plan module of the security agent manager application an updated investigation plan.

18. The computer program product of claim 9, wherein the performing the responsive action comprises assigning within the agent deployment module of the security agent manager application a third agent to a third task, the assigning causing executing, by the third agent, the third task, the executing the third task producing a third execution result.

19. A computer system comprising a processor and one or more computer readable storage media, and program instructions collectively stored on the one or more computer readable storage media, the program instructions executable by the processor to cause the processor to perform operations comprising:
decomposing within a decomposition module of a security agent manager application a signal into a set of attributes, the signal being received at a data input interface of the security agent manager application;
generating within an investigation plan module of the security agent manager application an investigation plan based on the set of attributes, the investigation plan comprising a set of actionable tasks;
identifying within an agent registry module of the security agent manager application a first agent capable of executing a first task of the set of actionable tasks;
assigning within an agent deployment module of the security agent manager application the first agent to the first task, the assigning causing executing, by the first agent, the first task, the executing the first task producing a first execution result; and
performing within a response module of the security agent manager application, upon receiving the first execution result at the data input interface of the security agent manager application, a responsive action, the responsive action based on the first execution result.

20. The computer system of claim 19, further comprising:
determining within the agent registry module of the security agent manager application that there is no agent capable of executing at least one task of the set of actionable tasks; and
training within a model trainer module of the security agent manager application a new agent, the training the new agent causing the new agent to be capable of executing the at least one task.
